(19) United States
(12) Patent Application Publication
(10) Pub. No.: US 2005/0278779 A1
(43) Pub. Date: Dec. 15, 2005

(54) System and method for identifying the source of a denial-of-service attack

(75) Inventors: Pramod N. V. Koppol, Aberdeen, NJ (US); Thyagarajan Nandagopal, Middletown, NJ (US)

Correspondence Address: SYNNESTVEDT & LECHNER, LLP, 2600 ARAMARK TOWER, 1101 MARKET STREET, PHILADELPHIA, PA, 191072950, US

(73) Assignee: Lucent Technologies Inc., Murray Hill, NJ (US)

(21) Appl. No.: 10/853,591

(22) Filed: May 25, 2004

(51) Int. Cl. H04L 9/00

(52) U.S. Cl. 726/22

(57) ABSTRACT

A system and method for identifying the source of a denial-of-service attack is described. In one implementation, flow information about packets transmitted through a network is collected at different points in the network. The flow level information is analyzed to reconstruct a path taken by a packet associated with a DoS attack to identify the source of such an attack.

### TECHNICAL FIELD

The present invention relates generally to network security, and more specifically, to identifying the source of a Denial-of-Service attack in a network environment, such as the Internet.

### BACKGROUND

A Denial-of-Service (DoS) attack typically occurs when a system and/or network is flooded with so much traffic that it is unable to process legitimate service requests. For example, a DoS attack may involve blasting a network node (such as a Web site, an Internet Service Provider (ISP), and other servers), with a large volume of traffic that exceeds its processing capabilities, thus knocking the afflicted node out the network for the duration of the attack.

There are numerous methods for launching a DoS attack. In most instances, the source of the attack (i.e., the attacker) conceals their true identity by falsifying their Internet Protocol (IP) source address in attack packets associated with a DoS attack, which is often referred to as spoofing. Accordingly, when a victim discovers itself under attack, it cannot determine the true identity of the attacker, making it difficult to stop the attack and eliminate malicious traffic associated with the DoS attack. To make matters worse, DoS attacks are some of the easiest attacks to mount, often relying on shortcomings associated with common transport and messaging protocols.

To defend against DoS attacks, many countermeasures consist of filtering packets using a firewall to separate legitimate from malicious packets. Also, bandwidth throttling and resource throttling can be used to prevent an overloaded web site from bringing down an entire server. Unfortunately, these methods are ineffective against many of the common types of DoS attacks. Many attackers are able to outsmart these methodologies using, for instance, legitimate agents to carryout an attack on behalf of a DoS attacker. Additionally, many filters and firewalls are incompatible with common protocols such as the Network Address Translation protocol (used for connecting networks together), Mobile IP, and other protocols.

Other counter measures aim at identifying the source of a DoS attack through traceback methodologies. Most traceback schemes are reactive in nature and attempt to identify paths along which attack packets may have traveled. For instance, one methodology proposes to record a history of every packet entering a particular domain. However, with gigabytes worth of packets passing through a network domain each second, recording every packet passing through a particular domain can quickly outstrip available storage capacities and processing overhead capabilities.

Other techniques attempt to identify the source of a DoS attack by sampling only portions of the packets traveling in a domain. While this technique alleviates some of the storage and processing problems associated with storing every packet, it often fails to record critical information that may establish a consistent pattern leading to the source of a DoS attack.

Thus, current solutions used to identify the source of a DoS attack are often ineffective and/or have many drawbacks associated with them. Accordingly, DoS attacks continue to pose a significant threat to networks and their constituent components (i.e., servers, routers, hosts, computers, etc.).

### SUMMARY

A system and method for effectively identifying the source of a Denial-of-Service (DoS) attack is described. The novel implementations described herein identify the source of a DoS attack based on flow information recorded and maintained in a network. In one exemplary implementation, flow information is collected at different points in the network. The flow information is retrieved from the different points and analyzed to reconstruct a path taken by a packet associated with a DoS attack. Based on the analysis the source of a DoS attack can be identified.

The described implementations, therefore, introduce the broad concept of performing flow-based traceback of DoS traffic to identify the source of a DoS attack. By identifying a particular flow to which one or more attack packets belong, it is possible to traceback where one or more DoS attacks originated. Unlike conventional per-packet DoS analysis traceback schemes that often rely on potentially spoofed packet information, flow-based traceback techniques rely on flow information that generally cannot be spoofed by a DoS attacker. The flow information can be stored and analyzed on a statistical basis reducing memory/processing overhead requirements.

### BRIEF DESCRIPTION OF THE DRAWINGS

The detailed description is described with reference to the accompanying figures. In the figures, the left-most digit(s) of a reference number identifies the figure in which the reference number first appears.

FIG. 1 illustrates an exemplary network in which flow information is collected at various points in the network to identify a source of a (DoS) attack.

FIG. 2 shows flow identifiers derived from a header of an IP packet, which are used to identify flows.

FIG. 3 shows an exemplary flow table maintained at an ingress router in an autonomous system.

FIG. 4 illustrates an exemplary physical representation of a computer platform used to implement various nodes in a network.

FIG. 5 illustrates an exemplary traceback system for use in a network.

FIG. 6 illustrates an exemplary method for identifying a source of a DoS attack.

### DETAILED DESCRIPTION

Overview

This disclosure is directed to a system and method for effectively identifying the source of a Denial-of-Service (DoS) attack. The novel implementations described herein use flow information about packets to identify a domain in which an attacker is launching a DoS attack. Although only passive identification methods are described herein, it is possible that active systems could be combined to take action to eliminate the DoS attack once the source of an attack is identified, such as by blocking the attack, removing the attacker(s) from a network, and/or notifying the relevant Internet Service Provider(s) (ISP) to take legal action against the attacker.

As used herein, a “flow” is generally defined as a stream (unidirectional or bi-directional) of packets traveling between two points in a network that all have the same characteristics. Nevertheless, a flow may include only a single packet sent from one point to another point in a network. A flow is identified by reading select information (called “flow identifiers”) from a header of one or more packets. In one implementation, the select information is read from the source Internet Protocol (IP) address, the destination IP address, the IP port, and/or the IP protocol-type portions of a header. In other implementations, it is possible that other select information may be read from packets.

As used herein, “flow information” refers to statistical information associated with flows collected at various points in a network, such as at the ingress and/or egress ports of autonomous systems. By analyzing flow information, it is possible to ascertain where a stream of packets originated or terminated. In other words, when a DoS attack is recognized, the flow information is retrieved from the different points and analyzed to reconstruct a path taken by at least one packet associated with the DoS attack. The analysis may involve querying each ingress port of an autonomous system starting with the autonomous system in which the victim node resides and tracing backwards from the victim's autonomous system to neighboring autonomous systems until the source(s) of a DoS attack (or at least the autonomous system(s) from which the attack is being launched) can be identified. It is also possible that the methodologies described herein can be used within an autonomous system, i.e., intra autonomous system attack-source identification.

The recording of flow information uses substantially less processing and memory resources than is required for the recording and processing of per-packet information as suggested by conventional literature. Accordingly, historical information about packet traffic may be retained for longer periods of time. Additionally, flow-based traceback methodologies are less vulnerable than existing approaches to DoS attackers with knowledge of the traceback system, since DoS attackers are unable to spoof field information associated with traffic flows.

As used herein, the term “DoS attack,” unless specifically specified, shall include all forms of denial of service attacks, such as, but not necessarily limited to, single source DoS attacks, distributed DoS attacks, and reflector attacks. It is assumed that the reader is familiar with each one of these specific attacks as well as possibly other types of DoS attacks. Nevertheless, a summary of each is briefly provided as follows:

A Single Source DoS attack typically involves an attacker launching a flood of packets from single host to overwhelm a victim. The source addresses are randomly selected. This type of attack relies on a power host and large network bandwidth to be of any use.

A Distributed DoS attack (DDoSs) typically involves subverting a number of nodes, e.g., through well-known security loopholes. These compromised nodes essentially become slaves of the attacker and act as launch points to inject traffic into the network. By summoning a reasonable number of compromised nodes, an attacker could potentially launch a large-scale network wide attack by cascading the traffic from multiple launch points. Launching a large-scale DDoS attack is proving easier than expected. For example, both e-mail attachments and active Web page contents have been exploited in a variety of ways to spread malicious content (such as viruses) that compromise network nodes. It is noted that a single Source DoS attack is a subset of the DDoS attack.

Currently the most common DoS attack, referred to as a “reflector” DoS attack (or reflector attack), involves an attack host (or group of hosts) sending a flood of attack packets to various benign hosts with the victim's Internet Protocol (IP) address as the source address of the attack packets. Each of the attack packets requires that the benign hosts respond to the attack packets. The benign hosts, also referred to as “reflectors,” assume that the request originated from the victim, because the source address of the attack packets are embedded with the victim's IP address. Accordingly, the reflectors send a reply back to the victim usually flooding the victim with traffic, thereby overwhelming it. Typically, the quantity of responses received by the victim is likely to be proportional to the quantity of reflectors.

Reflector DoS attacks are difficult to track since any traceback from a victim is likely to lead to the reflectors. Additionally, the innocent reflectors usually do not know that they are part of a DoS attack, since the traffic load on each of them may be low. So, while it may be possible to identify the reflectors, it is much more complicated to identify the true source of a DoS attack when the attacker uses a reflector-based attack in a timely manner.

Exemplary Network Architecture

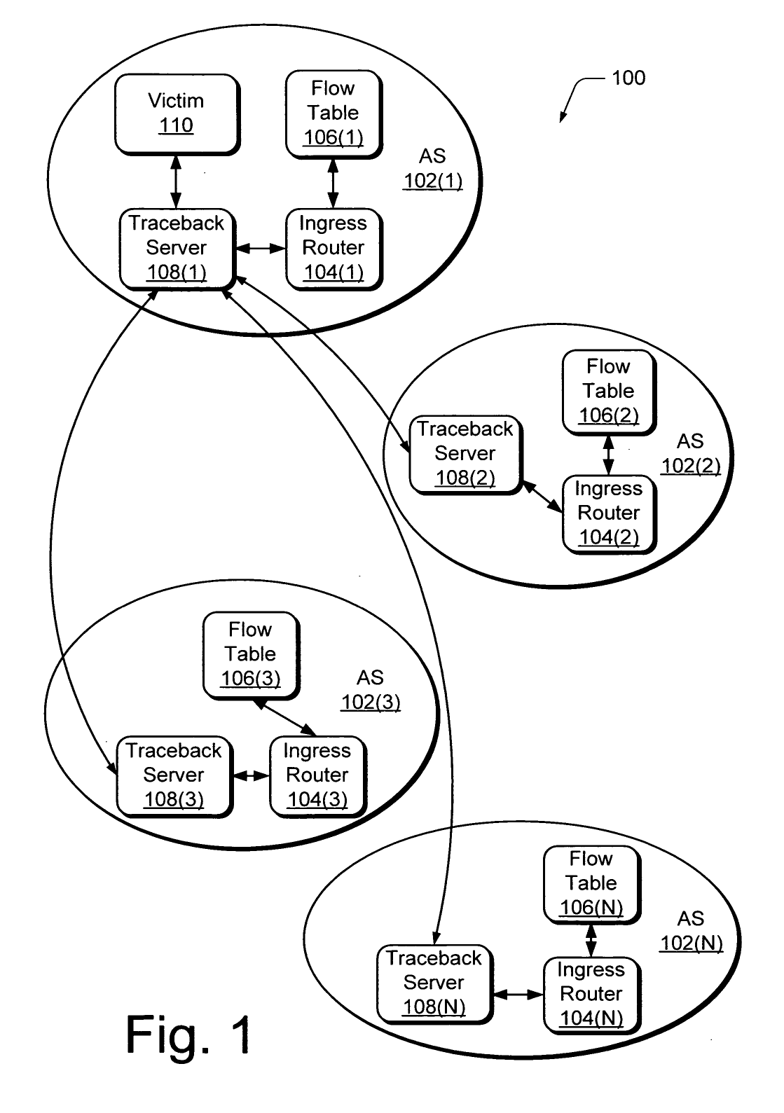

FIG. 1 illustrates an exemplary network 100 in which flow information is collected at various points to identify a source of a (DoS) attack. Network 100 is intended to represent any of variety of network topologies and types including wired and/or wireless networks. Network 100 may also include at least a portion the Internet.

In the illustrious embodiment, network 100 includes several autonomous systems 102(1), 102(2), 102(3), . . . , 102(N). Each AS may include one or more networks (not shown), such as local area networks (LANs) and/or wide area networks (WANs). Each autonomous system (AS), referred to generally as reference number 102, may be coupled together in a variety of different ways via computing devices such as gateways, routers, servers, bridges, etc. For example, each AS 102 includes one or more ingress routers, which serve as access points for packets to enter an AS (ingress routers may also be referred to as entry edge routers). In the illustrious embodiment, ingress routers 104(1), 104(2), 104(3), . . . 104(N) are shown in AS 102(1), 102(2), 102(3), . . . 102(N), respectively, although it is appreciated that are generally several ingress routers per AS. The term AS may also be referred to as a domain herein.

To collect flow information at various points in network 100 flow tables 106(1), 106(2), 106(3), . . . , 106(N) are maintained at each ingress router 104. These flow tables, referred to generally as reference number 106, are databases containing flow information collected from its respective ingress router 104. That is, each flow table 106 contains flow information about packets entering an AS 102. Each flow table 106 may be maintained by its respective ingress router 104 or may be maintained by other computer devices able to communicate with ingress routers 104. Additionally, if there is more than one ingress router, it is possible to aggregate information collected from each ingress router into a single flow table.

Alternatively, it is also possible to collect flow information at other locations in network 100, such as at all routers in the network or traffic engineering servers that monitor flow statistics in the AS 102.

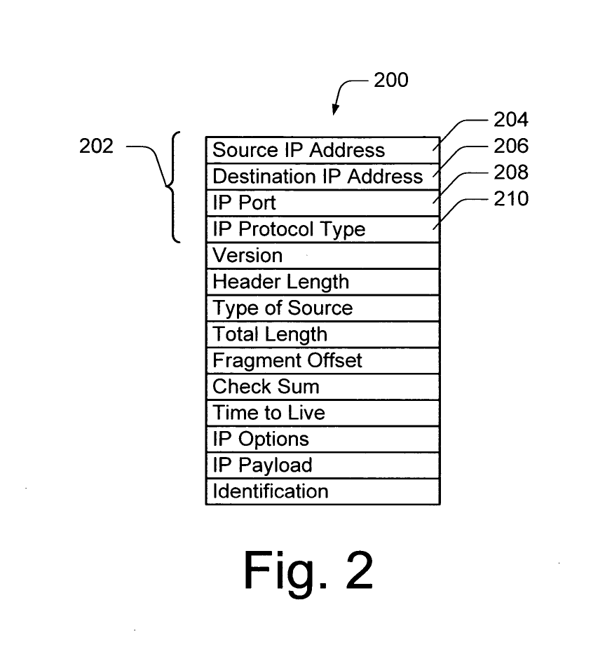

A flow is identified by reading select information (called “flow identifiers”) from a header of one or more packets received by each ingress router 104 of an AS 102. That is, for each incoming packet p, at a time t(p) a flow identifier i(p) is recorded. For instance, FIG. 2 shows flow identifiers 202 derived from a header 200 of an IP packet, which are used to identify flows. In one implementation, the select information is read from the source IP address 204, the destination IP address 206, the IP port 208, and the IP protocol-type portions (i.e., protocol) 210 of a header 200. The flow identifiers 202 enable flows to be uniquely identified.

Depending on the type of packets being sent, different flow identifiers may be used to determine flows. For instance with Internet Control Message Protocol (ICMP) it is only necessary to record the first type field. For other types of packets, other information may be recorded, such as the source, and destination port from the IP payload. In addition, a 1-byte protocol field in the IP packet can be used to further distinguish the flow. It is noted that ICMP packets do not have any port information.

Accordingly, to identify flows, only flow identifiers from the packet header, need be recorded, although it is possible that other select information may be read from packets. For example, the header length and/or the Time-To-Live (TTL) field can be logged. The TTL field can provide additional information on the maximum distance of the attack source from the logging point. In any event, the amount of information logged per flow is very small, less than 12 bytes for IPv4 packets. Moreover, the number of distinct flows in a router is orders of magnitude smaller when compared to the number of packets processed at a router and stored in conventional packet-based logging schemes.

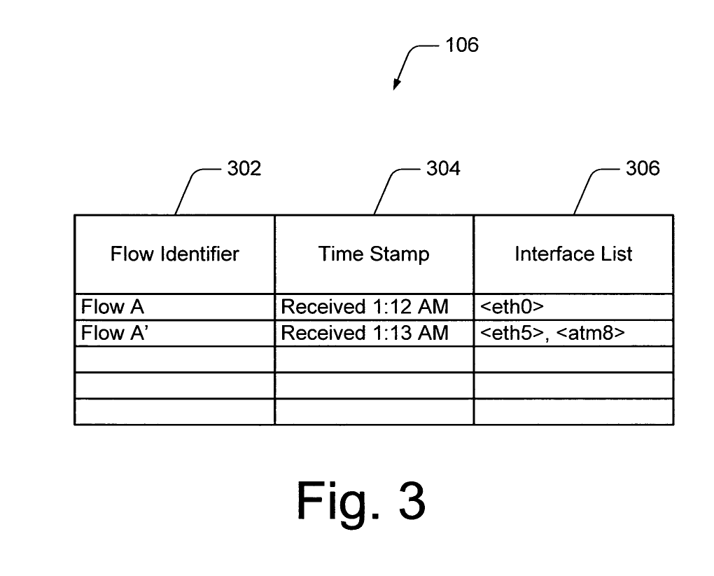

FIG. 3 shows an exemplary flow table 106 maintained at each ingress router 104. As indicated above, ingress routers 104 generally maintain flow tables 106, which serve as searchable databases. Each flow table 106 may be implemented using any of variety of conventional databases, examples of which include hash tables, plain text tables, SQL databases, Microsoft® Access database, and a variety of other databases.

Flow table 106 generally includes a flow identifier column 302 and timestamp column 304. Typically, each flow identifier associated with a flow is recorded in flow identifier column 302. A timestamp associated with each flow (the most recent time the flow was seen) is typically recorded in timestamp column 304 in tandem with the flow identifiers recorded in column 302. By using a timestamp in conjunction with each flow, it is possible to search for particular flows during a certain period of time. Additionally, the oldest entries in the table 106 may be erased or overwritten based on the timestamps, when the table reaches capacity. If table 106 is implemented as Content Addressable memory, there is less need to be concerned about memory reaching capacity.

In one implementation, flow table 106 also includes an interface list column 306 in which incoming interfaces on which a flow identifier is observed is recorded in flow table 106. The interface list from column 306 is used to distinguish between packets exiting a network and entering a network through the same router. Moreover, the list is used to identify the other autonomous system(s) 100 through which the flow entered the AS.

It should be noted that information might be distributed in flow tables 106 in other logical groupings with more or fewer parameters than shown in FIG. 3. For example, the flow information may be stored in a single table, or multiple tables of various logical groupings.

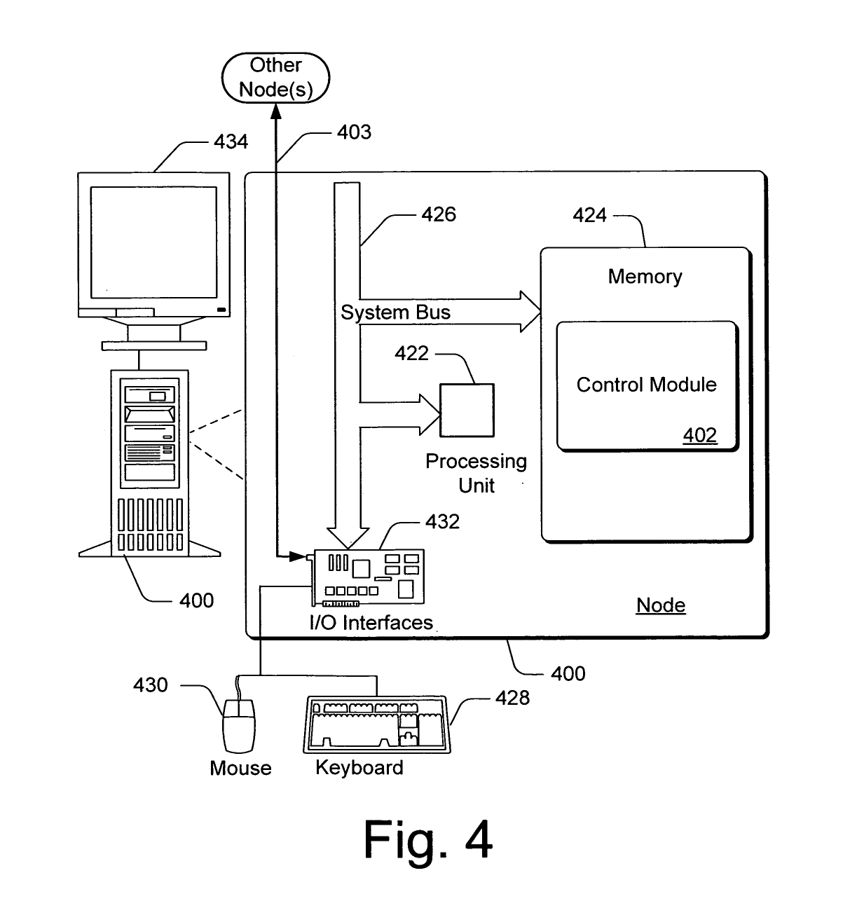

Referring back to FIG. 1, Each AS 102 also includes at least one traceback server 108(1), 108(2), 108(3), . . . , 108(N). In one exemplary implementation, each traceback server, referred to generally as reference number 108, is a computer device (see, i.e., computer platform 400 in FIG. 4) primarily configured to retrieve flow information from flow tables 106, communicate with other traceback servers, and communicate with victims of a DoS attack.

For instance, suppose a traceback server 108(1) receives notification of a DoS attack from a victim 110. Traceback server 108(1) will first query flow table 106(1) belonging to AS 102(1) searching for flow information pertinent to the DoS attack on victim 110. Once the flow information is retrieved, it is analyzed by the traceback server 108(1). If the flow information indicates that the attack packets originated from a neighboring AS, such as AS 102(2), traceback server 108(1) will communicate with a neighboring traceback server 108(2), and request that traceback server 108(2) query flow table 106(2) for information pertinent to the DoS attack. When traceback server 108(2) obtains the pertinent flow information it will forward the information directly back to traceback server 108(1). Traceback server 108(1) will then process the flow information to determine the next set of ASes to be queried. And the process will repeat propagating further away from the victim's 110 AS 102(1) to neighboring AS's 102(3), . . . , 102(N). This process will continue until it is possible for the traceback server 108(1) to aggregate the flow information and trace the DoS attack back to a set of/particular AS from which a DoS emanates. Now, it is possible to take action to eliminate the attack from the source(s), such as through filtering or other action as seen fit by the victim 10 or the AS that hosts the attack source(s).

Each traceback server 108 will communicate directly with the victim's traceback server, which in this example is traceback server 108(1). This approach enables communication to remain relatively simple, by having each traceback server communicate only with the victim's traceback server. Additionally, it allows the victim's traceback server, i.e., traceback server 108(1) to search for the attack host(s) in an ever-increasing ring of autonomous systems, searching among neighboring autonomous systems first, and then second level autonomous systems, and so on. This also eliminates having to relay information between traceback servers, which may increases the time to identify the source of an attack. Nevertheless, it is possible to set-up a system in which information is relayed between successive traceback servers, alternative implementations.

Additionally, in alternative implementation, the victim may have a dedicated server/firewall that can interact with its' traceback server to analyze flow information as opposed to the traceback server performing the flow analysis. Such situations might arise when the victims are enterprises that are clients of a larger AS 102.

With respect to the exemplary network 100 described above, it is also noted that the notation “N” denotes that there may be any number of devices. And as should be appreciated, different quantities of ingress routers 104, flow tables 106, and traceback servers 108 per autonomous system, may be used to implement the architecture of network 100.

It is also appreciated that each node in network 100 may have dual or triple functionality. For instance, an ingress router 104 may also serve as a traceback server in certain applications. Some of the methodological features that are to be described below may be implemented without necessarily having a traceback server. For instance, in an alternative implementation, it may be possible to eliminate traceback servers and have the victim perform all the analysis as well as retrieving information collected in other autonomous systems.

Having introduced the exemplary network environment, it is now possible to describe an exemplary physical platform that may be used to implement one or more nodes in network 100.

Exemplary Computer Platform

Any functionality provided by routers, traceback servers, and victims can be implemented in any general purpose or special purpose computing system. Examples of well known computing systems, environments, and/or configurations that may be suitable for use with any one of the nodes include, but are not limited to, personal computers, server computers, multiprocessor systems, microprocessor-based systems, network computers, routers, optical switches, wireless routers, minicomputers, mainframe computers, distributed computing environments that include any of the above systems or devices, and the like.

Additionally, any exemplary functionality provided by routers 104, traceback servers 108, and victim 110 may be described in the general context of computer-executable instructions, such as program modules, being executed by a computer. Generally, program modules include routines, programs, objects, components, data structures, logic, and other executable data that perform particular tasks or implement particular abstract data types. Functionality provided by network 100 can also be practiced in a distributed computing environment where tasks are performed by remote nodes that are linked through network 100. In a distributed computing environment, program modules may be located in both local and remote computer storage media including memory storage devices.

FIG. 4 illustrates an exemplary physical representation of a computer platform 400 used to implement various nodes in network 100. In particular, computer platform 400 represents any general purpose or special purpose computing system used to implement a node (e.g., routers, traceback servers, and/or victim) with minor modifications to hardware, firmware, and/or software. Computer platform 400 is only one example of computer platform and is not intended to suggest any limitation as to the scope of use or functionality of any of the nodes and networks described herein. Neither should the computer platform 400 be interpreted as having any dependency or requirement relating to any one or combination of components described herein.

Each node of network 100 includes a control module 402, which controls the operation of the node. Each control module 402 can be implemented in hardware, firmware, logic, software, or any combination of thereof. In the illustrative exemplary implementation control module 402 is implemented as a program module that may be described in the general context of computer-executable instructions, being executed by a computer, i.e., one or more processors in a processing unit 422. Control module 402 resides in memory 424.

Memory 424 typically includes a variety of computer readable media. Such media can be any available media that is accessible by computer platform 200 and includes both volatile and non-volatile media, removable and non-removable media. The computer-readable media provide non-volatile storage of computer readable instructions, data structures, program modules, and other data for computer platform 400. Any number of program modules can be stored in the computer readable media of memory 424, including one or more portions of control module 402.

It is also noted that portions of control module 402 may be stored in a remote memory storage device remote from computer platform 400. Additionally, even though control module 402 is illustrated herein as a discrete block, it is recognized that any of these components may reside at various times in different storage components of computer platform 400 and are executed by one or more processors of a computer, such as processing units 422.

A user can enter commands and information into computer platform 400 via input devices such as a keyboard 428 and a pointing device 430 (e.g., a “mouse”). Other input devices (not shown specifically) may include a microphone, a joystick and/or the like. These and other input devices are connected to computer platform 400 via input/output interfaces 432, such as a network or a wireless communication link. Computer platform 400 is connected to other nodes via a communication link 403. In particular, communication link 403 connects input/output interfaces 432 to network 100. Finally, a monitor 434 or other type of display device can also be connected to computer platform 400 to provide graphical information to a user.

Having introduced an exemplary network and an exemplary computer platform for each node in the network, it is now possible to describe an exemplary flow-based traceback system used to identify the source of DoS attack in network 100.

Flow-Based Traceback System

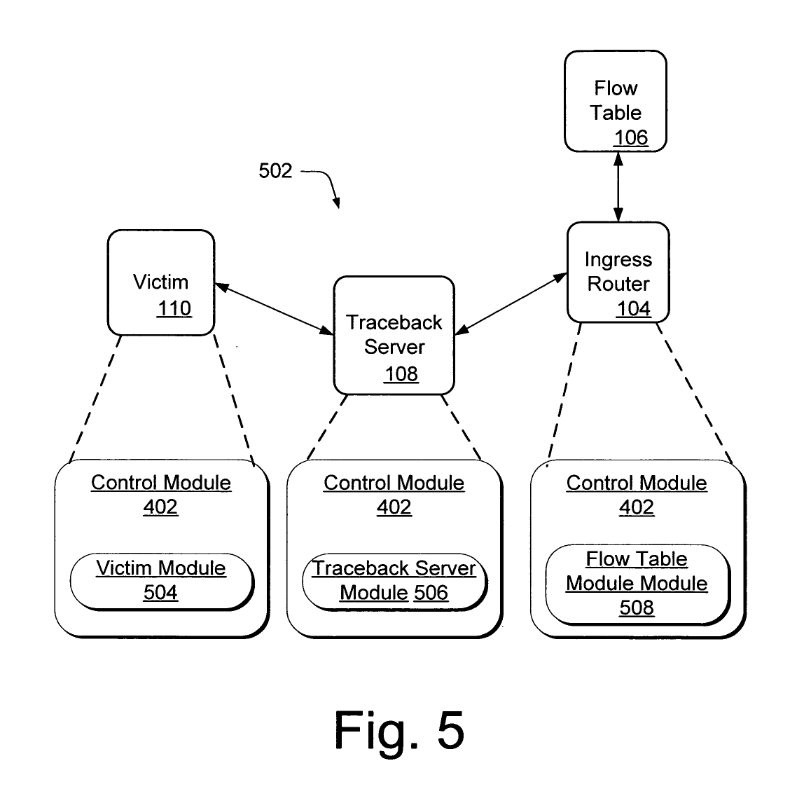

FIG. 5 illustrates an exemplary traceback system 502 for use in network 100. Portions of traceback system 502 are distributed throughout network 100, such as incorporated in ingress routers 104, traceback servers 108 and victim 110. Traceback system 502 is typically stored in control module 402 (FIG. 4) of the computer platform (ingress routers 104, traceback servers 108, and victim 110) for which it is associated. For example, in one implementation, traceback system 502 represents computer-executable instructions executed by a processing unit 422 (FIG. 4) of a computer, but could also be implemented in hardware or any combination of hardware, firmware, logic, and software.

In the illustrious implementation, traceback system 502 includes: a victim module 504, a traceback server module 506, and a flow table module 508. In one implementation, victim module 504 is configured to enable a victim 110 to notify a traceback sever 108(1) to initiate the traceback of flows associated with a DoS attack. Once flow information associated with a DoS attack is retrieved from flow tables 106 and sent to victim 110, victim module 504 enables a victim to analyze the flow information to identify the source of a DoS attack. This may involve constructing of a trace graph showing the attack path(s) of attack packets.

In one implementation, traceback server module 506 is configured to enable traceback server 108(1) to communicate with other traceback servers 108, as well as to search query tables 106 for flow information associated with DoS attacks. Each time information relevant to a DoS attack is located from a particular flow table 106, traceback server module 506 facilitates the transfer of the flow information back to traceback server 108(1) for relay to victim 110 if needed.

In one implementation, flow table module 508 is configured to enable ingress routers 102 to collect flow information observed at various points in the network, such as ingress routers 104. Flow table module 508 records select header information (flow identifiers 202) associated with flows to build a statistical log about flows in flow tables 106.

Although traceback system 502 is shown to include three distinct functional blocks (victim module 504, traceback server module 506, and flow table module 508), it is understood that when actually implemented in the form of computer-executable instructions, logic, firmware, and/or hardware, that the functionality described with reference to each block may not exist as separate identifiable modules. The traceback system 502 may also be integrated with other components or as a module in a larger system. In most instances, whether integrated or not, traceback system 502 enables flow information about packets collected at different points in a network to be retrieved from these collection points; and analyzed to reconstruct a path taken by a packet associated with the DoS attack to identify the source of the DoS attack.

Having introduced various components of a traceback system 502, it is now possible to describe how traceback system 502 traces back the source(s) of DoS attack(s).

Methods of Operation

Methods for identifying the source of a DoS attack may be described in the general context of processor-executable instructions. The described methods may also be practiced in distributed computing environments where functions are performed by remote processing devices that are linked through a communications network. In a distributed computing environment, computer-executable instructions may be located in both local and remote storage media, including memory storage devices.

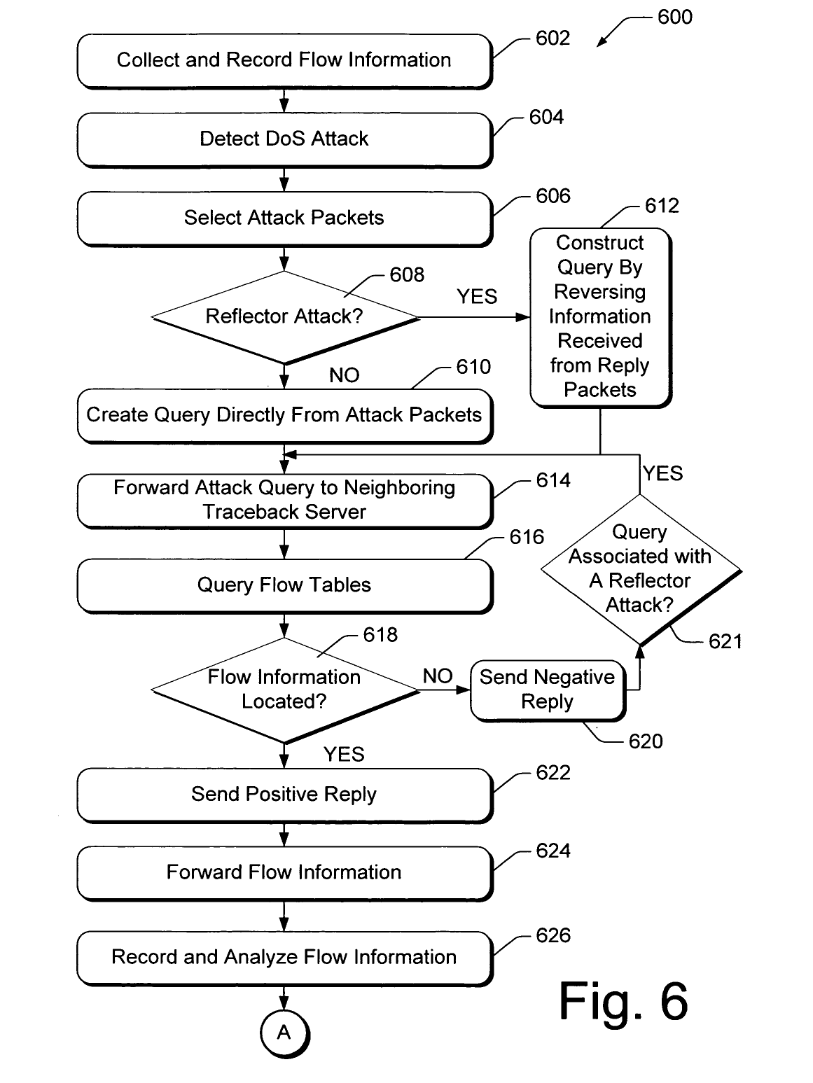

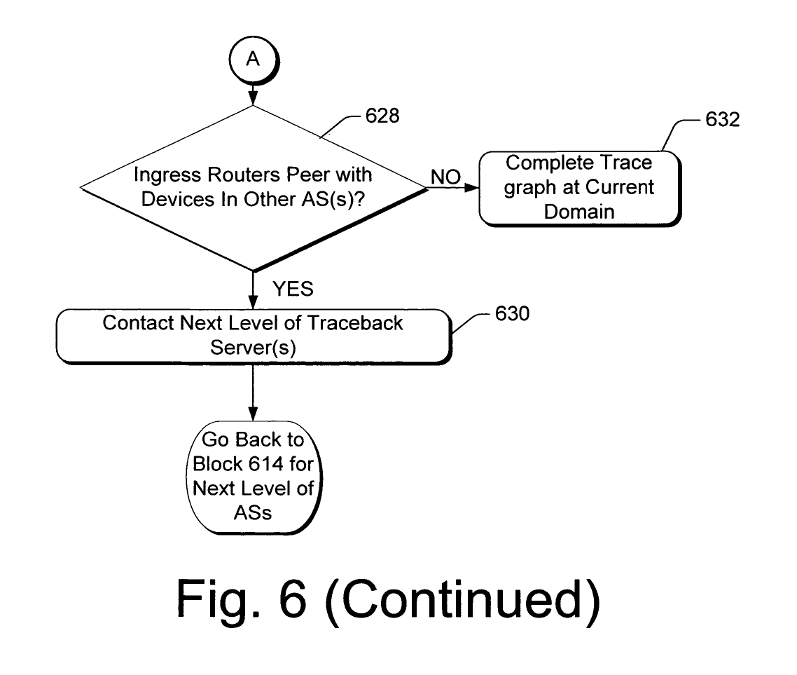

FIG. 6 illustrates an exemplary method 600 for identifying a source of a DoS attack. Method 600 enables a victim in a network to reconstruct a path taken by attack packets from the victim through the network to the source of the DoS attack. Method 600 includes blocks 602 through 632 (each of the blocks represents one or more operational acts). The order in which the method is described is not to be construed as a limitation, and any number of the described method blocks can be combined in any order to implement the method. Furthermore, the method can be implemented in any suitable hardware, software, firmware, or combination thereof.

Exemplary method 600 shall be described interchangeably with reference to FIGS. 1, 2, 3, 4 and 5. For purposes of discussion, method 600 is illustrated from the perspective of victim 110 in FIG. 1, but can apply to any node in a network 100 (FIG. 1).

In block 602, flow information observed at various points in a network are collected and recorded. The flow information recorded at each location in the network provides a profile of network traffic observed at the collection points. For example, flow information is collected at various ingress routers 104 (FIG. 1) of various autonomous systems 102 (FIG. 1). Flow table modules 508 operating in association with ingress routers 104 records select header information (flow identifiers 202 (FIG. 2)) associated with flows to build a statistical log about flows in flow tables 106 maintained in the various autonomous systems 102. This flow information can be analyzed to trace back the source of a DoS attack.

In block 604, a victim detects a DoS attack. For instance, a victim 110 may recognize a large quantity of (potentially invalid) service requests that are disproportionate to previous levels of similar service requests for a particular period of time. Such a large quantity of service requests may indicate may indicate that a DoS attack is being perpetrated. There are many other ways to detect whether a DoS attack is being perpetrated. For instance, a victim 110 (FIG. 1) may detect that there is unusual quantity of protocol errors associated with requests or a large quantity of fragments associated with requests. Again, all these scenarios are indicative of a DoS attack and for purposes of this discussion, most DoS attack detection methods schemes used to detect such anomalies may be used in conjunction with method 600. Such detection methodologies may be incorporated as a module used conjunction with traceback system 500 (FIG. 5).

In block 606, a subset of packets (referred to interchangeably as attack packets) associated with the DoS attack is selected. The subset may comprise one or more packets that a victim perceives as being part of a DoS attack. In one implementation, victim module 504 (FIG. 5) is configured to enable a victim 110 to select a subset of attack packets.

In decisional block 608, a determination is made whether the DoS attack is a reflector attack or other type of DoS attack. A victim assumes a reflector attack is being perpetrated if the victim receives a large number of “reply” messages from different hosts. On the other hand, if a victim is receiving a large number of messages from a single source or the messages are not in response to reply messages, then the victim assumes the DoS attack is a single source DoS or DDoS attack. In one implementation, victim module 504 (FIG. 5) is configured to determine whether a reflector attack is being perpetrated.

If according to the NO branch of decisional block 608, a determination is made that a reflector attack is not being perpetrated, then method 600 proceeds to block 610. On the other hand, if according to the YES branch of decisional block 608, a determination is made that a reflector attack is being perpetrated, then method 600 proceeds to block 612.

In block 610, if the determination is made that a non-reflector DoS attack is being perpetrated, then a query can be created directly from attack packets received by the victim. A query is constructed by selecting flow IDs from the header of one or more attack packets. The query may comprise flow ID information, such as their source IP address 204 (FIG. 2), destination IP address 206, the IP port 208, and the IP protocol-type portions (i.e., protocol) 210. The query may also comprise a time (e.g., time stamp) the attack packet(s) were received by the victim. In one implementation, victim module 504 (FIG. 5) is configured to construct an attack query.

In block 612, if the determination is made that a reflector attack is being perpetrated, then a query is constructed by reversing information from received reply packets. That is, flow ids associated with reply packets received by the victim are reversed. In particular, the source and destination IP addresses are reversed, as well as IP port 208. Reversing flow identifiers of attack packets received from the reflectors, enables a flow analysis to be performed starting with the reflectors, which are one level away from the victim.

For example, suppose that there is one attack host and n number of reflectors. Also suppose that the targeted victim with IP address x using non-ICMP packets, and let the IP addresses of the reflectors be y1, y2, . . . , yn. Let the targeted port at the victim be Pₓ and that of the reflector be Pⁱ_{y}. The query packets sent by the attack host to a reflector yᵢ will have flow identifiers (<src_IP, dest_IP, src_port, dest_port>) of Query_d=<x, yᵢ, Pₓ, =while the packets from reflector yᵢ to the victim will have flow identifiers R_{id}=<yᵢ, x, Pⁱ_{y}, Pₓ>. Thus, given any one flow identifier R, it is possible to reconstruct the identifier of the corresponding query flow identifier Query_{id} between a reflector and the attack host, thereby locating the attacker.

It is noted that the number of attack hosts is usually much smaller than the number of reflectors for a reflector-based DoS attack. For instance, suppose that are M attack hosts and N reflectors. Assume that the reflectors are uniformly distributed between attack hosts. The number of unique DoS flow identifiers seen at the victim will be N. If the victim chooses a random K of the n identifiers to trace back, then on an average, the traceback process will identify M*K/N attack hosts. Once the attack hosts is reduced below a certain threshold, the DoS traffic from the remaining attack hosts can be managed more easily, resulting in reduced DoS effects, and the DoS traffic from the remaining attack hosts can be managed more easily, while all remaining attack hosts are traced back. As a result of using flow-based traceback, the number of attack packets arriving from each reflector is immaterial.

In block 614, once the attack query has been constructed, it is forwarded to the traceback server in the Autonomous System in which the victim resides. For example, victim module 504 is configured to enable a victim 110 to notify traceback sever 108(1) to initiate the traceback of flows associated with a DoS attack using the attack query constructed by victim module 504.

In block 616, flow tables belonging to the AS in which the victim resides are queried for flow information pertinent to the DoS attack on the victim, based on the attack query constructed above (blocks 610 and 612). For instance, suppose a traceback server 108(1) receives notification of a DoS attack from a victim 110. Traceback server 108(1) will first query flow table 106(1) belonging to AS 102(1) searching for flow information pertinent to the DoS attack on victim 110.

In a decisional block 618, a determination is made whether any flow information is recorded in a flow table associated with the attack query. For example, traceback server module 506 is configured to enable traceback server 108(1) to query flow tables 106 for flow information associated with a DoS attack. If according to the NO branch of decisional block 618, a determination is made that no flow information is found in the flow table, then method 600 proceeds to block 620. On the other hand, if according to the YES branch of decisional block 618, a determination is made that flow information matching the attack query is present in a flow table, process 600 proceeds to block 622.

In block 620, if there are no flow identifiers associated with an attack query found in a flow table, a negative reply is sent in response to the attack query. For example, flow table 106(1) will send a negative reply to traceback server 108(1) that no flow identifiers associated with the query were found. This either means that the source of the attack emanated from within the autonomous system in which the victim resides (or the current AS being in which flow tables are being queried), or the particular ingress router did not observe any flows associated with the attack. Potentially, however, other ingress routers (if there is more than one per AS) observed the flows. In one implementation, flow table module 508 (FIG. 5) is configured to enable ingress routers 102 to collect flow information observed at various points in the network, such as ingress routers 104, and respond to search queries initiated by traceback servers 108.

Block 620 leads to decisional block 621, which check whether the query processed was for a reflector attack or not. If YES, the traceback server forwards this query to all other neighboring traceback servers in accordance with block 614. The act of forwarding the query to neighboring traceback servers is performed, because the path of the attack packets from the attack host to the reflector might not be on the path from the reflector to the victim. Therefore, all traceback servers in the network should be queried, to be thorough. Although, not shown, if the query was not part of the query, then the query does not have to be forwarded to neighboring traceback servers.

In block 622, if according the YES branch of decisional block 618 flow identifiers associated with an attack query are found in a flow table, a positive reply is forwarded to the traceback server (or other devices) for analysis. For example, flow table 106(1) will send a positive reply to traceback server 108(1) indicating that flow identifiers associated with the query were found. This means that traffic associated with attack packets were observed by at least one particular ingress router 104(1) in AS 102(1). Potentially, other ingress routers (if there is more than one per AS) may also have records indicating that their particular ingress router observed traffic flows associated with the attack packets.

In block 624, the flow information associated with the attack query is forwarded by the traceback server to the victim. For example, traceback server 108(1) forwards the flow identifiers associated with the attack query to the victim 110. In one implementation, server module 506 facilitates the transfer of the flow information from traceback server 108(1) to victim 110.

In block 626, the flow information associated with the attack query is recorded and analyzed. In one implementation, victim module 504 is configured to enable victim 110 analyze the flow information to identify the source of a DoS attack. This may involve constructing the first piece of a trace graph showing the attack path(s) of attack packets based on flow information retrieved from the attack query.

In a decisional block 628, a determination is made whether the ingress routers in the current domain peer with another AS, i.e., whether an AS is peered with an egress (exit point) router of the corresponding neighboring AS. If according the YES branch of decisional block 628, the ingress routers in the current domain peer with another AS, then method 600 proceeds to block 630. On the hand if according the NO branch of decisional block 628, the ingress routers in the current domain do not peer with another AS, then method 600 proceeds to block 632.

In block 630, if the determination is made that the ingress router is the current domain peers with another AS, then the traceback servers in those ASs are contacted by the victim's traceback server to collect any flow information from the flow tables therein. At this point the process repeats itself.

In block 632, if the determination is made that the ingress router in the current domain does not peer with another AS, then the ingress router from the current domain is added to the trace graph at the victim's AS.

Method 600 illustrates that flow information enables a victim to determine the source of DoS attack by collecting flow information at various points in a network and the analyzing the flow information when a DoS attack is detected to determine where the attack originates.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method for identifying a source of a Denial-of-Service (DoS) attack, comprising:
retrieving flow information about packets collected at different points in a network; and
analyzing the flow information to reconstruct a path taken by a packet associated with the DoS attack to identify the source of the DoS attack.

2. The method as recited in claim 1, wherein the flow information includes traffic flow statistics about packets passing through the network.

3. The method as recited in claim 1, wherein the flow information includes traffic flow statistics about packets passing through the network and wherein the traffic flow statistics comprises flow identifiers associated with packets, each flow identifier comprising at least one of a source Internet Protocol (IP) address, a destination IP address, IP port and IP prototype.

4. The method as recited in claim 1, further comprising recording traffic flow statistics about packets traversing one or more autonomous systems when collecting the flow information at different nodes in the network.

5. The method as recited in claim 1, wherein at least one of the different nodes is an ingress router for an autonomous system.

6. The method as recited in claim 1, wherein a traceback server analyzes the flow information on behalf of a victim.

7. The method as recited in claim 1, wherein analyzing the flow information to reconstruct a path taken by a packet associated with the DoS attack comprises iteratively querying one or more of the different points in the network where flow information is collected starting with a victim node and ending at a point in the network where flow information associated the DoS attack is not observed.

8. A method, comprising:
maintaining logs comprising flow information about packets flowing through a network at various monitoring points in the network; and
querying one or more of the logs using flow identifiers associated with attack packets of a Denial-of-Service (DoS) attack to identify specific flow-information maintained in one or more of the logs associated with the DoS attack to reconstruct a path taken by the attack packets to identify where the DoS attack emanates.

9. The method as recited in claim 8, wherein the flow information comprises statistical information about the packets flowing through the network.

10. The method as recited in claim 8, wherein the monitoring points are ingress routers of each Autonomous System (AS).

11. A computer, comprising:
a memory comprising a set of computer-executable instructions; and
a processor coupled to the memory, wherein the computer-executable instructions when executed by the processor, direct the computer to identify the source of a Denial-of-Service attack in a network, by: retrieving flow information about packets collected at different points in a network; and analyzing the flow information to reconstruct a path taken by a packet associated with the DoS attack to identify the source of the DoS attack.

12. The computer as recited in claim 11, wherein the flow information includes traffic flow statistics about packets passing through the network.

13. The computer as recited in claim 11, wherein the flow information includes traffic flow statistics about packets passing through the network and wherein the traffic flow statistics comprises flow identifiers associated with packets, each flow identifier comprising at least one of a source Internet Protocol (IP) address, a destination IP address, IP port and IP prototype.

14. One or more computer-readable media having stored thereon computer executable instructions that, when executed by a computer, causes the computer to:
retrieve flow information about packets collected at different points in a network; and
analyze the flow information to reconstruct a path taken by a packet associated with the DoS attack to identify the source of the DoS attack.

15. A system, comprising:
a victim node;
a traceback server; and
a victim module comprising computer-executable instructions that when executed by the victim node and the traceback server, enable the victim node to notify the traceback sever to initiate the trace back of flows associated with a DoS attack, and enables the traceback server to analyze flow information collected from various points in the network to identify the source of a DoS attack.

16. The system as recited in claim 15, further comprising a traceback server module comprising computer-executable instructions that when executed by the traceback server enables the traceback server to communicate with other traceback servers, and to search flow tables for flow information associated with DoS attacks.

17. The system as recited in claim 15, further comprising a traceback server module comprising computer-executable instructions that when executed by the traceback server enables the traceback server to communicate with other traceback servers, and to search flow tables for flow information associated with DoS attacks, and each time flow information relevant to a DoS attack is located from a particular flow table, the traceback server module facilitates the transfer of the flow information back to the traceback server.

18. The system as recited in claim 15, further comprising a flow table module comprising computer-executable instructions that when executed by a router enables the router to collect flow information in a network observed by the router, and store the flow information in a flow table, the flow information comprising header information from packets associated with flows.

19. A method for identifying a source of a Denial-of-Service (DoS) attack, comprising:
constructing a query from an attack packet;
using the query to retrieve flow information about packets collected at different points in a network; and
analyzing the flow information to reconstruct a path taken by the attack packet to identify the source of the DoS attack.

20. The method as recited in claim 19, further comprising determining whether the attack packet received by the victim is part of a reflector DoS attack.

21. The method as recited in claim 19, wherein constructing a query from an attack packet comprises:
determining whether the attack packet received by the victim is part of a reflector DoS attack; and
reversing a flow identifier from the attack packet received by a reflector, wherein the flow identifier comprises a source and destination IP address, if the determination is made that the attack packet received by the victim are part of a reflector DoS attack.

22. The method as recited in claim 19, wherein constructing a query from an attack packet comprises:
determining whether the attack packet received by the victim is part of a reflector DoS attack; and
creating the query directly from the attack packet received by a victim by selecting flow identifiers from a header of the attack packet, if the determination is made that the attack packet received by the victim are not part of a reflector DoS attack.
